(19) United States
(12) Patent Application Publication
(10) Pub. No.: US 2017/0017794 A1
(43) Pub. Date: Jan. 19, 2017

(54) METHOD AND DEVICE FOR PROTECTING A COMPUTING APPARATUS AGAINST MANIPULATION

(71) Applicant: Siemens Aktiengesellschaft, München (DE)

(72) Inventor: Rainer Falk, Poing (DE)

(21) Appl. No.: 15/120,685

(22) PCT Filed: Feb. 13, 2015
(86) PCT No.: PCT/EP2015/053044

§ 371 Date: Aug. 22, 2016

(30) Foreign Application Priority Data
Mar. 31, 2014 (DE) 10 2014 206 006.0

(51) Int. Cl. G06F 21/57

(52) U.S. Cl. CPC G06F 21/57; G06F 21/575; G06F 2221/2141; G06F 2221/2105

(57) ABSTRACT

A method for protecting a computing apparatus against manipulation, which computing apparatus includes a plurality of components, which are designed to execute software and which have associated access rights is provided. The method includes the following steps: withdrawing a number of the access rights to the components during a starting process of the computing apparatus and specifying a subset of the access rights to the components on the basis of the withdrawn access rights, which subset cannot be changed during the execution of the software. By withdrawing access rights, the integrity protection is improved for the computing apparatus, because, in the event of a successful attack, the manipulations that can be performed by the manipulated software are limited. The disclosed further relates to a computer program product and to a device for protecting a computing apparatus against manipulation.

### CROSS-REFERENCE TO RELATED APPLICATIONS

This application claims priority to PCT Application No. PCT/EP2015/053044, having a filing date of Feb. 13, 2015, based off of German application No. DE 102014206006.0 having a filing date of Mar. 31, 2014, the entire contents of which are hereby incorporated by reference.

### FIELD OF TECHNOLOGY

The following relates to a method for protecting a computing apparatus against manipulation. In addition, the following relates to a computer program product and a device for protecting a computing apparatus against manipulation.

### BACKGROUND

The integrity of computing apparatuses such as industrial control systems is an essential objective for ensuring their correct functionality. During the operation of networked control systems, manipulation of the control system may occur via the data connection, for example, the Ethernet. To carry out such impermissible manipulations, for example, an attacker may take advantage of security vulnerabilities in the implementation.

Therefore, there is a need to limit the manipulation which is able to be carried out via the malicious software or manipulated software, even in the event of a successful attack against the executed software of a control system or control device.

For protecting against attacks, conventional protective measures are implemented, such as installing patches to close gaps, virus scanners, or application whitelisting. Nevertheless, it is not generally completely possible to rule out the occurrence of successful attacks.

From the document WO 2012/119218 A, it is known to use a Linux kernel module for monitoring integrity. In addition, so-called trusted platform modules (TPMs) are known, which enable access to a cryptographic key only if a platform configuration register (PCR) of the TPM contains a predefined value. The value of the PCR is reset via a reset signal.

During operation as well as during the startup of the software, a measured value may be supplemented, for example, a hash value of a software module. The new PCR value is obtained as a hash value of the current PCR value and the provided measured value. As a result, a call of such a function is enabled only if a certain software configuration exists (as a consequence of the measured value for updating the PCR), from which the expected PCR value is obtained. It is thus possible to verify the integrity of the boot process, since the identical sequence of PCR measured values exists only in the case of a non-manipulated boot process.

However, this requires a complex cryptographic calculation. In addition, limitation of the different PCR values only affects a function of the TPM itself. However, a function of the main processor unit (main CPU) or the operating system executed on it is not limited by this.

Furthermore, rights administration is generally known on IT systems, in which users (human users or system users) are able to call a function only if an authorization (access right) exists. On conventional systems, a primary user (root, administrator) is provided, which has any, i.e., all, rights. This may be implemented in such a way that the system does not perform an authorization check for such a primary user. Furthermore, so-called mandatory access control systems are known, in which authorizations are fixedly determined via attributes or features of the users and the accessed object, for example, as a function of a predetermined security step. However, such systems are very complex to administer. Furthermore, the additional checks disadvantageously result in delays.

Furthermore, generally, an access control which is a function of a state is known (state-based access control). In this case, the current system state determines whether access is permissible or impermissible. Furthermore, with respect to functional safety-critical systems, sealing configuration settings is known. In this case, a human user is able to seal a safety configuration specified by him/her via a service interface. A sealed safety configuration cannot be modified via the service interface, only completely deleted.

### SUMMARY

An apsect relates to improving the protection of a computing apparatus against manipulation.

Accordingly, a method for protecting a computing apparatus against manipulation is provided, which includes a plurality N, where N≧2, of components configured for executing software and having associated access rights. The method includes the steps of: revoking a number M, where 1≦M<N, of the access rights to the components during a start process of the computing apparatus, and determining a subset X, which is invariable during the execution of the software, where X=N−M, of the access rights to the components, based on the revoked access rights.

An access right associated with a component specifies the authorization or permission to access the access the component. However, if the access right associated with the component is absent, it is not possible to access the component. In particular, the access rights, i.e., the authorizations, which components associated with these access rights access, determine the configuration setting of the computing apparatus.

During the start process of the computing unit, a number M of the access rights are thus revoked, and the subset X (X=N−M) of the access rights to the components during the execution of the software is thus established. Sealing of the configuration setting thus takes place during the start process. Subsequently, the configuration setting may no longer be modified by the executed software until the next system startup or reset.

As a result, the integrity protection is improved for the computing apparatus, since the manipulations which are able to be carried out by the manipulated software are limited even in the event of a successful attack.

The following example, in which a control device (embedded system) executes control software on a microcontroller (CPU) as a computing apparatus, is intended to illustrate embodiments of the present invention. During the start process (boot process), extensive authorizations (access rights) are required by the executed software in order to configure components, for example, hardware assemblies, or in order to start and configure software components. These functions may be implemented by so-called start scripts which are executed as an administrator user or root user (i.e., as a user having all authorizations).

By means of the provided method for protecting against manipulation, the root user himself/herself revokes access rights (authorizations) for additional configurations after completion of the configuration. Changes to the configuration may no longer be made even by a root user; this is again possible only at the next system startup or reboot.

Therefore, a configuration setting, for example, the call of a function or an API (application programming interface) of a microcontroller-based control device, may be carried out after a system start (reboot) by software executed on the microcontroller only until sealing of the configuration setting takes place. In particular, during the boot process, a configuration of operating system kernels may take place. After sealing has taken place, modification under software control is not possible even by the root user. Modification is again possible only after a new restart.

In this context, manipulation may be understood to mean any unauthorized external intervention into the software of the computing apparatus which leads to undesirable changes in the software or data connected with it. Manipulation of the software may thus also lead to undesirable changes in the components (execution environment) of the computing apparatus, or to manipulation of the computing apparatus.

As a result, in particular, write access may also be prevented via the revocation of certain access rights to certain configuration memories, such as EEPROM memories or flash memories, so that overwriting these memories is prevented during operation.

According to one specific embodiment, the plurality of access rights is mapped via flags which may be stored in a memory device of the computing apparatus.

As a result, the revocation of the access rights and the administration of the invariable subset of the access rights may be administered via these flags. In another variant, these flags may also be implemented in hardware.

According to another specific embodiment, the computing apparatus is operated in a first operating mode, in which the plurality of access rights to the components exists (is set), and in a second operating mode following the first operating mode, in which only the ascertained subset of the access rights to the components exists.

According to another specific embodiment, the first operating mode is designed as a boot process of the software on the computing apparatus.

According to another specific embodiment, the second operating mode is designed as a normal operation of the computing apparatus with booted software.

The normal operation may also be referred to as regular operation.

According to another specific embodiment, the first operating mode and the second operating mode are differentiated via a single flag.

For example, a set flag may indicate the first operating mode, whereas a flag which is not set may indicate the second operating mode.

According to another specific embodiment, for storing the flag, a memory unit is used which is modifiable only in a single direction during the execution of the software via a command generated by means of software.

In this specific embodiment, the flag may be set via a software instruction, but may be reset only via a hardware reset. This increases the security and the integrity protection of the computing apparatus.

In this case, a digital flip-flop is preferably used as the memory unit for storing this single flag.

The digital flip-flop constitutes a particularly simple and economical option for implementing this memory unit.

According to another specific embodiment, the ascertained subset of the access rights is stored as a list or as a matrix in a memory device of the computing apparatus.

This list may, for example, constitute a whitelist of approved program files or configuration files. This whitelist may be configured and then sealed in the operating system kernel. Subsequently, modification of the whitelist is no longer possible during operation, even by a user having root rights or administrator rights. After sealing is completed, the boot process is continued or application programs are started.

According to another specific embodiment, the number of access rights to the components is revoked during the start process of the computing apparatus in the case of the occurrence of a predetermined event.

According to another specific embodiment, the number of access rights to the components is revoked during the start process of the computing apparatus if a timer expires.

According to another specific embodiment, the number of access rights to the components is revoked during the start process of the computing apparatus if a predetermined event occurs or if a certain timer expires.

According to another specific embodiment, the components configured for the execution of the software include at least one hardware component, in particular a network interface, an input/output unit, a watchdog, a memory, a sensor, an actuator or a processor, and/or a software component, in particular a file or a process.

According to another specific embodiment, the computing apparatus is a control device, a personal computer, an embedded device, a server, or a control computer.

According to another specific embodiment, the software is an operating system, an operating kernel, a kernel module, a driver, a user-space program, or a loading routine.

According to another specific embodiment, the following steps are provided: generating a piece of reference information, which is invariable during the execution of the software, for an integrity check of the computing apparatus during the start of the computing apparatus, according to which the subset of the access rights to the components is determined, and carrying out the integrity check by means of the generated piece of reference information.

Furthermore, a computer program product is provided, which initiates the execution of the method as described above on a program-controlled apparatus.

A computer program product, for example, a computer program means, may, for example, be provided or supplied as a storage medium, for example, a memory card, USB stick, CD-ROM, DVD, or also in the form of a downloadable file from a server in a network. This may, for example, take place in a wireless communication network via the transmission of a corresponding file via the computer program product or the computer program means.

According to another aspect, a device for protecting a computing apparatus against manipulation is provided, which includes a plurality of components configured for executing software and having associated access rights. The device includes a first unit and a second unit. The first unit is configured to revoke (block) a number of the access rights to the components during a start process of the computing apparatus. The second unit is configured to determine a subset of the access rights to the components, which is invariable during the execution of the software, based on the revoked access rights.

Each unit, for example, the first or second unit, may be implemented through hardware and/or also through software. In the case of an implementation through hardware, each unit may be designed as a device or as part of a device, for example, as a computer or as a microprocessor. In the case of an implementation through software, each unit may be designed as a computer program product, as a function, as a routine, as part of a program code, or as an executable object.

The specific embodiments and features described for the provided method are correspondingly valid for the provided device.

According to another aspect, a computing apparatus is provided which includes a plurality of components configured for executing software and having associated access rights, and a device as described above for protecting against manipulation of the computing apparatus.

Additional possible implementations of embodiments of the present invention also include combinations, which are not explicitly mentioned, of features or specific embodiments described previously or below with respect to the exemplary embodiments. Those skilled in the art will also add individual aspects or improvements or enhancements to each basic form of embodiments of the present invention.

### BRIEF DESCRIPTION

Some of the embodiments will be described in detail, with reference to the following figures, wherein like designations denote like members, wherein:

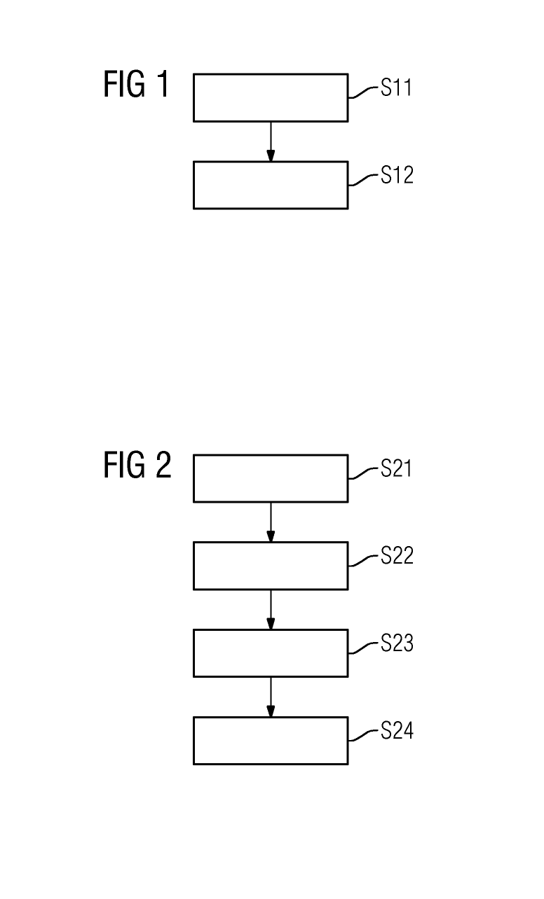

FIG. 1 shows a schematic flow chart of a first exemplary embodiment of a method for protecting a computing apparatus against manipulation;

FIG. 2 shows a schematic flow chart of a second exemplary embodiment of a method for protecting a computing apparatus against manipulation;

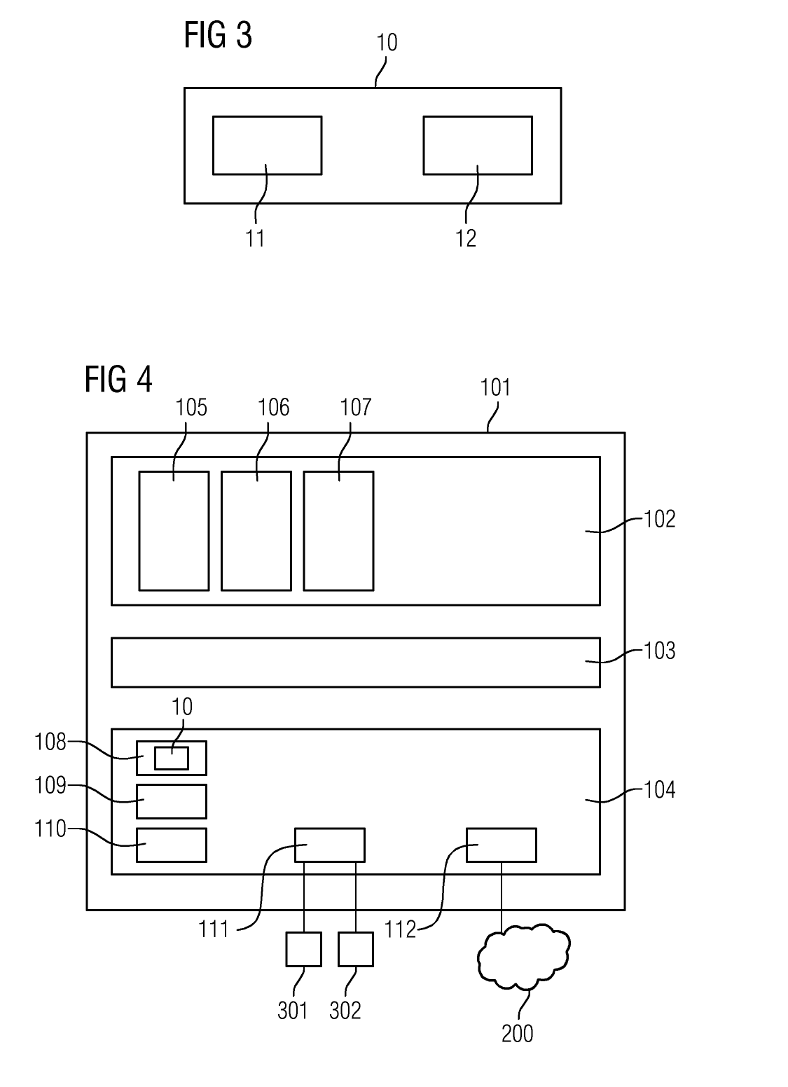

FIG. 3 shows a schematic block diagram of an exemplary embodiment of a device for protecting a computing apparatus against manipulation;

FIG. 4 shows a schematic block diagram of an exemplary embodiment of a computing apparatus;

FIG. 5 shows a schematic flow chart of a third exemplary embodiment of a method for protecting a computing apparatus against manipulation;

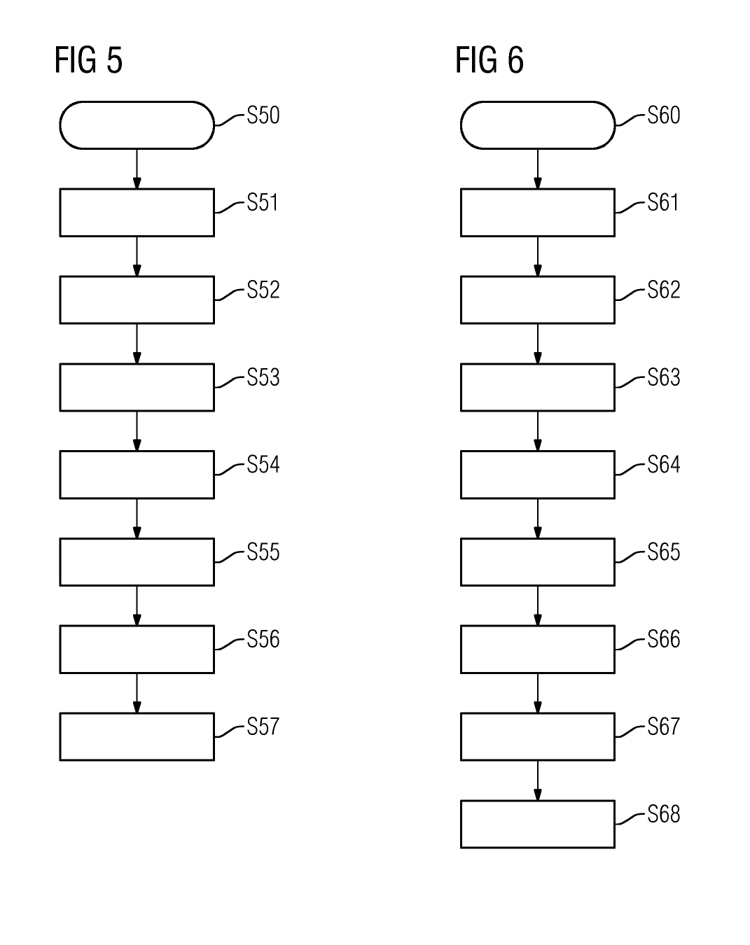

FIG. 6 shows a schematic flow chart of a fourth exemplary embodiment of a method for protecting a computing apparatus against manipulation; and

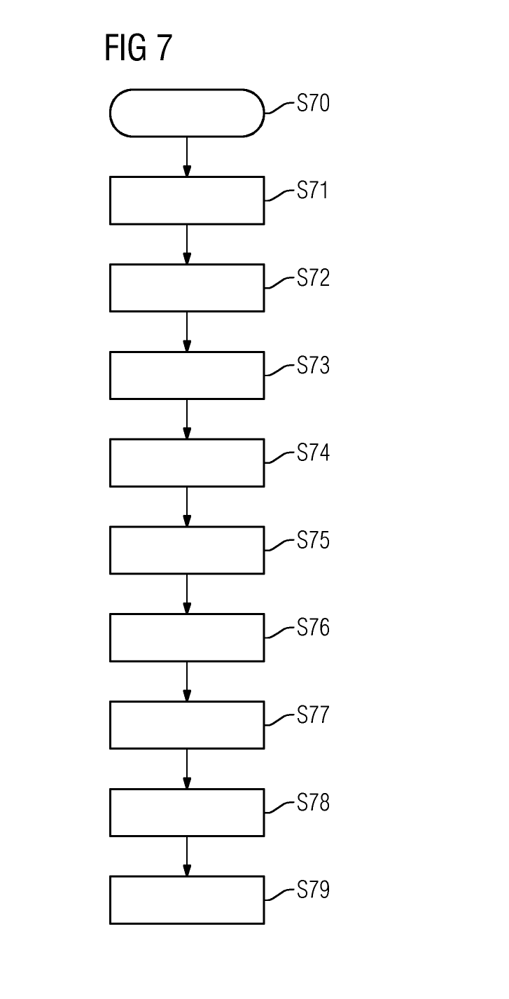

FIG. 7 shows a schematic flow chart of a fifth exemplary embodiment of a method for protecting a computing apparatus against manipulation.

### DETAILED DESCRIPTION

FIG. 1 depicts a schematic flow chart of a first exemplary embodiment of a method for protecting a computing apparatus against manipulation.

The computing apparatus includes a plurality of components configured for executing software and having associated access rights. An access right associated with a component specifies the permission to access the component. However, if the access right associated with the component is absent, i.e., the access right is not granted, it is not possible to access the component.

The access rights may be administered via flags. The flags are, for example, stored in a memory unit of the computing apparatus. The components of the computing apparatus configured for executing the software may include hardware components and/or software components. Examples of hardware components include network interfaces, input/output units, watchdogs, memories, sensors, actuators, or processors. The software components may include files or processes.

The computing apparatus is, for example, a control device, a control system, an embedded control device, a personal computer, an embedded device, a server, or a control computer. The computing apparatus includes, for example, a microcontroller or a microprocessor. The software is, for example, an operating system, an operating kernel, a kernel module, a driver, a user-space program, or a loading routine.

The method of FIG. 1 includes the following steps S11 and S12.

In step S11, a number of the access rights to the components are revoked during a start process of the computing apparatus. If, for example, N refers to the plurality of the access rights and M refers to the number of revoked access rights, 1≦M<N is valid.

In step S12, a subset X of the access rights to the components, which is invariable during the execution of the software, is determined based on the revoked access rights (X=N−M).

As a result, the computing apparatus is preferably operated in a first operating mode in which the plurality of the access rights to the components exists (is set), and in a second operating mode following the first operating mode in which only the ascertained subset of the access rights to the components exists. The first operating mode is, for example, a boot process of the software, wherein the second operating mode is then a normal operation or regular operation of the computing apparatus. For example, the first operating mode and the second operating mode are differentiated via a single flag.

In particular, for storing the flag, a memory unit is used which is modifiable only in a single direction during the execution of the software via a command generated by means of software. Thus, this flag may be set via a software instruction, but may be reset only via a hardware reset. An example of such a memory unit is a digital flip-flop. The flag may also be referred to as a sealing flag.

For example, the ascertained subset of the access rights is administered as a list or as a matrix. The number of access rights to the components is revoked during the start process of the computing apparatus in the case of the occurrence of a predetermined event (event-triggered) and/or if a timer expires (time triggered). As a result, the sealing of the configuration setting may take place via a software instruction (event-triggered) or automatically in a time-controlled manner, for example, after one minute or five minutes. The timer is preferably set during a reset or a system start. After the expiration of a predefinable period of time after a reset or a system restart, sealing thus takes place automatically. In particular, the memory unit may include the timer which automatically sets the flag of the memory unit after the expiration of the predefinable period of time following a hardware reset.

The time-controlled variant may be designed as a backup variant and has the advantage that sealing automatically takes place independently of the executed software, i.e., even without the executed software explicitly initiating sealing.

FIG. 2 shows a schematic flow chart of a second exemplary embodiment of a method for protecting a computing apparatus against manipulation. The computing apparatus, the software, and the components may have the characteristics and features as described for FIG. 1.

The method of FIG. 2 includes the steps S21 to S24.

In step S21, a piece of reference information for an integrity check of the computing apparatus during the start of the computing apparatus is generated and stored. This piece of reference information is to be invariable during the later execution of the integrity check.

In step S22, a number of the access rights to the components are revoked during the start process of the computing apparatus. Thus, sealing takes place. In this case, write access to the piece of reference information stored in step S21 is specifically blocked. For this purpose, the sealing flag may be set via a software instruction.

In step S23, a subset of the access rights to the components, which is invariable during the execution of the software, is determined based on the revoked access rights.

In step S24, an integrity check is carried out by means of the generated piece of reference information. The steps S23 and S24 may also be carried out in the reverse sequence or simultaneously.

FIG. 3 depicts a schematic block diagram of an exemplary embodiment of a device 10 for protecting a computing apparatus 101 against manipulation. The computing apparatus 101 may include the characteristics and features as described for FIG. 1. An example of this computing apparatus 101 is shown in FIG. 4.

The device 10 of FIG. 3 includes a first unit 11 and a second unit 12.

The first unit 11 is configured to revoke a number of the access rights to the components during a start process of the computing apparatus 101.

The second unit 12 is configured to determine a subset of the access rights to the components, which is invariable during the execution of the software, based on the access rights revoked by means of the first unit 11.

FIG. 4 shows a schematic block diagram of an exemplary embodiment of a computing apparatus 101. The computing apparatus 101 may be an embedded control device. The control device 101 includes an application area 102 (user mode, applications), an operating system area 103 (kernel mode, operating system), and hardware 104.

The application area 102 may contain various applications 105, 106, and 107. The hardware 104 includes a CPU 108, various memories 109, 110, for example, a RAM memory 109 and a flash memory 110, an input/output unit 111, and a network interface 112 (CNI communication network interface). The CPU 108 includes the device 10 according to FIG. 3. S/A modules 301, 303 may be coupled via the input/output unit 111. The network interface 112 is configured to couple the computing apparatus 101 to a network 200, for example, a LAN (local area network).

The operating system 103 is executed on the hardware 104, for example, as embedded Linux. The operating system kernel is executed in kernel mode 103. The kernel 103 may call any operations, i.e., no access control is provided within the operating system kernel. The applications 105 to 107 are executed as processes via the kernel 103. A (system) user is associated with a process (for example, as root, user, control). As a function thereof, authorizations (access rights) are associated with a process. A process is only able to call operating system functions if the required authorization exists. The operating system 103 is loaded from a boot loader during the start process. Multiple-stage boot concepts may also be implemented. For example, an initial boot loader may load a second-stage boot loader from the flash memory and execute it. This boot loader loads the operating system image from the flash memory 110 and executes it. This boot loader loads the operating system image from the flash memory 110 into the RAM memory 109 and passes the execution control. The operating system 103 starts at the beginning with the execution of boot scripts. In this case, for example, kernel modules are loaded into the operating system kernel. Hardware 104 is configured. Furthermore, system processes are started. At the end of the boot process, the application programs 105 to 107 are started.

FIGS. 5 to 7 show three variants of how sealing may be integrated into the boot process. Thus, FIG. 5 shows the following sequence of method steps S50 to S57:
S50: Reset;
S51: First stage of the boot loader;
S52: Second stage of the boot loader;
S53: OS boot loader;
S54: OS kernel;
S55: Startup scripts;
S56: Sealing the kernel configuration;
S57: Starting the application(s)

In addition, FIG. 6 shows the following sequence of method steps S60 to S68:
S60: Reset;
S61: First stage of the boot loader;
S62: Second stage of the boot loader;
S63: OS boot loader;
S64: OS kernel;
S65: Startup scripts (first part);
S66: Sealing the kernel configuration;
S67: Startup scripts (second part);
S68: Starting the application(s)

Furthermore, FIG. 7 shows the following sequence of method steps S70 to S79:
S70: Reset;
S71: First stage of the boot loader;
S72: Second stage of the boot loader;
S73: OS boot loader;
S74: OS kernel;
S75: Startup scripts (first part);
S76: Sealing the kernel configuration;
S77: Startup scripts (second part);
S78: Sealing reference information for integrity check
S79: Starting the application(s)

Sealing may take place, for example, after the completion of the startup scripts (for example, see step S55) or after completion of a first part of the startup scripts (for example, see step S66). It is also possible to provide multiple seals (see steps S76 and S78), which relate to a different functionality or at least a somewhat different functionality. Thus, for example, a piece of reference information for an integrity check of the computing apparatus may be sealed (see step S78) before the regular operating mode of the control device 101 is started.

In the figures, identical or functionally identical elements have been provided with the same reference numerals, unless otherwise specified.

Although the present invention has been described based on exemplary embodiments, it may be modified in manifold ways.

1. A method for protecting a computing apparatus against manipulation, which includes a plurality of components configured for executing software and having associated access rights, including:
revoking a number of the access rights to the components during a start process of the computing apparatus, and
determining a subset of the access rights to the components, which is invariable during the execution of the software, based on the revoked access rights.

2. The method as claimed in claim 1, wherein the plurality of the access rights is mapped via flags which may be stored in a memory device of the computing apparatus.

3. The method as claimed in claim 1, wherein the computing apparatus is operated in a first operating mode in which the plurality of the access rights to the components exists, and in a second operating mode following the first operating mode in which only the ascertained subset of the access rights to the components exists.

4. The method as claimed in claim 3, wherein the first operating mode is designed as a boot process of the software and the second operating mode is designed as a normal operation of the computing apparatus.

5. The method as claimed in claim 3, wherein the first operating mode and the second operating mode are differentiated via a single flag.

6. The method as claimed in claim 5, wherein for storing the flag, a memory unit is used which is modifiable only in a single direction during the execution of the software via a command generated by means of software.

7. The method as claimed in claim 6, wherein a digital flip-flop is used as the memory unit for storing the flag.

8. The method as claimed in claim 1, wherein the ascertained subset of the access rights is stored as a list or as a matrix in a memory device of the computing apparatus.

9. The method as claimed in claim 1, wherein the number of access rights to the components is revoked during the start process of the computing apparatus in the case of the occurrence of a predetermined event and/or if a timer expires.

10. The method as claimed in claim 1, wherein the components configured for the execution of the software include at least one hardware component, in particular a network interface, an input/output unit, a watchdog, a memory, a sensor, an actuator or a processor, and/or a software component in particular a file or a process.

11. The method as claimed in claim 1, wherein the computing apparatus is a control device, a personal computer, an embedded device, a server, or a control computer.

12. The method as claimed in claim 1, wherein the software is an operating system, an operating kernel, a kernel module, a driver, a user-space program, or a loading routine.

13. The method as claimed in claim 1, wherein:
generating a piece of reference information, which is invariable during the execution of the software, for an integrity check of the computing apparatus during the start of the computing apparatus, according to which the subset of the access rights to the components is determined, and
carrying out the integrity check by means of the generated piece of reference information.

14. A computer program product which initiates the execution of a method as claimed in claim 1 on a program-controlled apparatus.

15. A device for protecting a computing apparatus against manipulation, which includes a plurality of components configured for executing software and having associated access rights, including:
a first unit for revoking a number of the access rights to the components during a start process of the computing apparatus, and
a second unit for determining a subset of the access rights to the components, which is invariable during the execution of the software, based on the revoked access rights.
